(19) United States
(12) Patent Application Publication
(10) Pub. No.: US 2008/0109851 A1
(43) Pub. Date: May 8, 2008

(54) Method and system for providing interactive video

(76) Inventors: Ashley Heather, New York, NY (US); Lincoln Brown, Lexington, KY (US); Alberto Escarlate, Westport, CT (US); Anthony Zeoli, Yonkers, NY (US); Matthew Robinson, New York, NY (US); Charles Darling V., Houston, TX (US)

Correspondence Address: KENYON & KENYON LLP, ONE BROADWAY, NEW YORK, NY, 10004, US

(21) Appl. No.: 11/585,410

(22) Filed: Oct. 23, 2006

(51) Int. Cl. H04N 5/445; H04N 7/16; H04N 7/10; H04H 9/00; H04N 7/025

(52) U.S. Cl. 725/60; 725/19; 725/32; 725/61

(57) ABSTRACT

A method and system are described for providing an interactive video player. The method may include, responsive to a first user input, generating a secondary display from a primary display, wherein the primary display is an active video and the secondary display is a frame captured from the primary display. The method may also include, responsive to a second user input, generating a tertiary display from the secondary display, said tertiary display including product information about at least one item shown in the secondary display.

### BACKGROUND

The present invention relates generally to interactive video, and more specifically to viewers' interactions with a video display device for the selection and subsequent retrieval of information about products or items featured within the interactive video that is shown on a video display device.

In existing video techniques, a video may include a compilation of various image frames generated from or by any number of sources that generate and provide an output. With the growth of interactive video, a user is provided with the means to interact with the video content provider using basic interaction functions. For example, sporting statistics may be provided, responsive to the user pressing a button when watching a sports program. More advanced systems may allow a user to conduct an on-screen vote in a competition program. These systems are relatively primitive and are limited by requiring the display device to be capable of performing and supporting these enhanced interactive features. In the event the display device does not include the interaction capability, the video enhancements are lost to the viewer.

Product placement is a promotional tactic used by marketers to showcase the commercial products or services used in a video, typically in an exchange with the video creator. Product placements can be categorized into two separate categories, explicit and implicit placements. Explicit placements include the display of a particular branding feature, such as a logo or other distinguishing feature that allows a viewer to readily recognize the item(s). Implicit placements are the opposite, wherein the featured product is not expressly identified and, consequently, the user may not be able to readily distinguish the item itself based only on viewing the item in the video program.

With the advent of alternative revenue-generating techniques for video development, including commercial skipping features common in time-shifting video devices, such as a digital video recorder, product placement has become a commonly used technique for advertisers to reach viewers. Based on the inherent nature of video display in current systems, such as with a standard set top box and a television display or a computing device, which displays a video feed or downloaded video, implicit product placement offers limited benefits because viewers are unable to view, recognize and identify a vast majority of the placed products. Therefore, under existing video display techniques, only explicit product placements provide reasonable benefits to advertisers.

Another common problem with interactive video is that the interaction impedes the viewing pleasure of other viewers in a multi-viewer environment. For example, if a family is watching an interactive video and one viewer wants to invoke an interactive feature, the interaction interferes with the viewing pleasure of other family members. Under existing interactive systems and methods, the single user would have to pause or otherwise alter the single video image while invoking the interactive feature. This can be very disruptive and undesirable to other viewers in a multi-viewer environment.

There currently exist techniques that provide for some level of interaction in an interactive video with product or video information. For example, a digital video disc (DVD) may include an interactive feature at the conclusion of the video, including the display of products or elements featured in the movie itself. In other techniques, interactive video may allow a user to pause the video and to invoke or switch into an interactive mode, where a remote control device or some input device could affect the cursor placement and may be used to provide an overlay of product information.

Existing techniques allow for merging the gap between implicit and explicit product placements in interactive videos. However, these existing techniques are problematic in a multi-viewer environment, or where a user does not want to pause the video display itself. There are also situations where a user may be unable to pause a video display, such as when a television set top box does not have any buffering ability or a video specifically excludes pausing activity. In such cases, the desired interactive television features would be unavailable, because the existing techniques require the adjustment or alteration of the current or live video display, whether it be pausing the displayed images, or changing the video display to an alternative display, such as a secondary track on a DVD, for example.

Another problem with existing techniques that require a user to click on (or otherwise identify) a product depicted in the interactive video occurs when the video is fast-moving. A product may be depicted for a very brief moment, thereby making it difficult for the user to select and/or click on the product before it disappears from the display.

### BRIEF DESCRIPTION OF THE DRAWINGS

FIG. 1 illustrates an interactive video player, in accordance with an example embodiment of the present invention.

FIG. 2 illustrates a media player with a primary, secondary and tertiary display, in accordance with an example embodiment of the present invention.

FIG. 3 illustrates a system for providing interactive video, in accordance with an example embodiment of the present invention.

FIG. 4 illustrates the steps for playing a video clip for a user and receiving user input, in accordance with an example embodiment of the present invention.

FIG. 5 illustrates the steps for playing a video clip for a user, in accordance with another example embodiment of the present invention.

FIG. 6 illustrates the steps for playing a video clip for a user, in accordance with yet another example embodiment of the present invention.

FIG. 7 illustrates a system for providing interactive video, in accordance with an example embodiment of the present invention.

FIG. 8 illustrates a sample screen shot of a video being displayed in the active video display in accordance with one embodiment of the present invention;

FIG. 9 illustrates a multi-display sample screen shot in accordance with one embodiment of the present invention;

FIG. 10 illustrates a sample screen shot of a secondary display in one embodiment of a product linking process;

FIG. 11 illustrates a multi-display sample screen shot of a product linking process including the secondary display of FIG. 10.

FIG. 12 illustrates another multi-display sample screen shot of a product linking process, in accordance with one embodiment of the present invention; and

FIG. 13 illustrates another multi-display sample screen shot of a product linking process in accordance with another embodiment of the present invention.

### DETAILED DESCRIPTION

An interactive video player may be configured to display a video clip to a plurality of viewers through a general display device. In one embodiment, the video player may be a set top box, personal computer, or any other type of transmission or broadcast receiving device capable of receiving, decoding (if needed) and processing the video for subsequent display to a viewable display device. The video clip content may include product placements featured in the video. A user, who may be one of the viewers, may trigger a still image from the video clip to be saved for later review without disrupting the playing of the video and/or the viewing experience for other viewers. The saved still image may include metadata of products featured in the still image. The user may obtain information on products shown in the image and compile images and products into a user gallery available to the public. The product information may include purchase information on where the product may be purchased, as well as other marketing and merchant information.

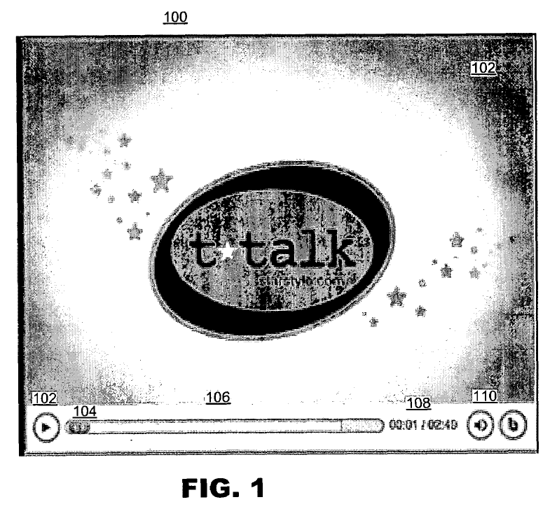

FIG. 1 illustrates a representative video display 100 viewable on a media player or a display device, as provided by a video broadcast receiver, such as a television set top box or other type of video player or receiver. The display 100 includes a primary video display 102 showing the video content, which may be viewed in a multi-user viewing environment such as multiple viewers in front of a television. Additionally, in another embodiment, this video content may be on a single viewer display device, such as a personal computer or portable viewing device.

A media player having the video display 100 may include a plurality of controls accessible to a user. The controls may include a play button 102, which may toggle between a play mode and a pause mode during a playback of a video clip. In one embodiment, the control functions may be viewable on the video display 100, such as when the user may utilize a graphical user interface or tactile input to interface with the video player. In addition, the control functions may be configured to be hidden when the video clip is being played. In another embodiment, where the video content is received from a set top box or other type of video display generating or storage device, the controls may be omitted from the viewing area, as the control functions are provided by a remote control or other type of input device.

In the illustrated sample video display 100, a play position marker 104 may indicate what portion or current position of the video clip is being played by its position within a seek bar 106. The play position marker 104 may also be clicked and dragged within the seek bar 106 to a portion of the video clip. The broadcast station may be a traditional cable broadcaster broadcasting video to appropriate receivers, a server or computing platform capable of streaming, distributing, feeding or otherwise allowing access to one or more media files, or any other suitable device in a local or networked environment capable of providing media files for subsequent display. The video may include plain video signals, or may include additional metadata and other information relevant to the video content. In another embodiment, the video clip may be delivered from a video player such as a DVD player, a digital video recorder, or other device configured to provide media content to a receiver.

A play time indicator 108 may indicate the current play position of the video clip, as well as the total play time of the video clip. A sound control 110 may provide the user with controls relating to an audio portion associated with the video clip. For example, the sound control 110 may allow the user to increase a volume of the audio portion of the video clip. The sound control 110 may also allow the user to decrease the volume or mute the audio portion.

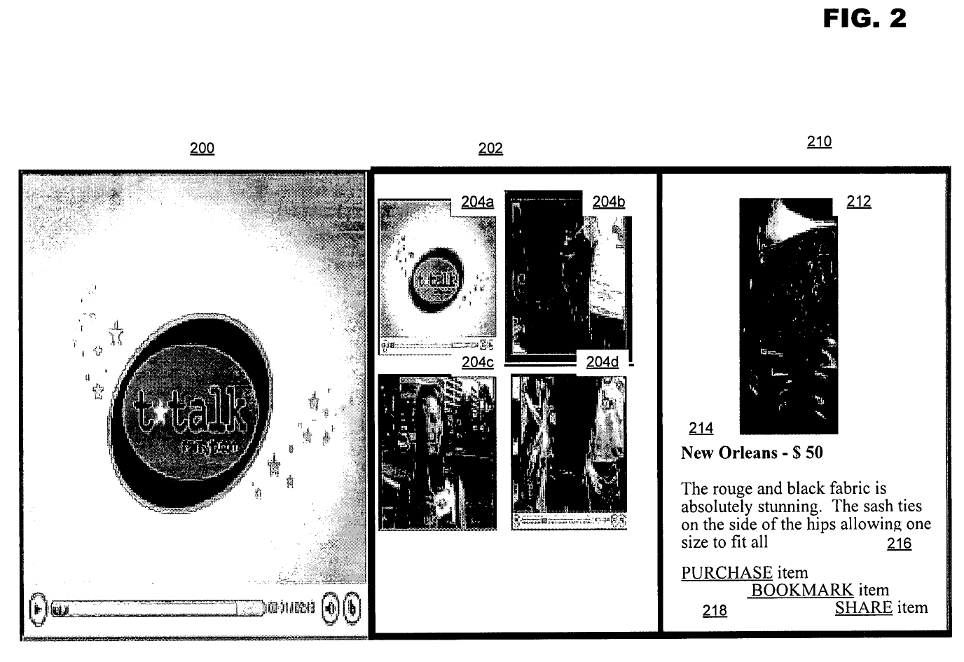

FIG. 2 illustrates a media player with a tri-split display, in accordance with one embodiment of the present invention. The tri-split display may include a media player video display 200, a gallery 202 and a product information 210. The tri-split display may be configured to play a video clip on a receiver display device for multiple viewers, where the video clip is provided from a transmission device and viewable on a receiving device. For example, in one embodiment, the video clip may be stored locally and/or streamed from a network broadcast station, i.e., streamed or downloaded across the Internet. In another embodiment, the video clip may be broadcast from a television broadcast station across a video transmission medium to a television set top box or a receiver device, or it may be retrieved from a previously stored video location, such as a set top box or a receiver having digital video recording capabilities. The video clip may include product information and other metadata for products included in the video clip, such as explicit or implicit product placements, merchant information, marketing data, etc.

In one embodiment, a video clip may be processed by an identification step, where products included in the video clip are manually or automatically tagged for later identification. For example, the system may automatically recognize outlines of products depicted in a frame of a video clip. Alternatively, the system may require an administrator to manually outline a product depicted in the video clip for tagging. After the product is tagged, it may be identified automatically or manually. For example, tagged products may be shown to an administrator, who inputs appropriate product information. This identification process may be locally or remotely performed by, for example, an applet or other software application running on a local processor, or a server-based software service provided to the user.

As described in FIG. 1, the media player (video display) 100 may be shown on a television set with a set top box or a broadcast receiver in a multi-viewer environment. In another embodiment, the media player, as depicted in FIG. 2, may be configured to execute and be viewed on a personal computer. In one embodiment, the tri-split display of the media player may only be presented to the user after the user has indicated a frame to be captured from the video.

The media player video display 200 may be similar to the video display 100, depicted in FIG. 1, and may play a video clip for one or more viewers. While the video clip is being played, the user may provide a user input indicating a still image to be saved from the video clip. The media player 200 may save a still image from the current play position of the video clip. The still image may be displayed in a gallery 202, described below. For example, the displayed media content may automatically be displayed in a tri-split display when the user provides an input to trigger capture of a frame from the video clip. The captured frame may then be displayed, along with the product information associated with products displayed in the captured frame. The captured frame or collection of captured frames may be linked or otherwise associated with media, a particular user or other frames having the same or similar products therein. In one embodiment a user may search or otherwise access other media having linked products associated therewith, for example viewing other instances of the display of the linked product(s).

When the receiver or the media player receives the user input, it may save the still image displayed in the video display 200. For example, the still image may be saved to a storage medium accessible to the receiver or the media player, such as a local hard disk, a web-accessible database, flash memory, or any other suitable storage medium. The still image may be saved with product information and metadata associated with the products displayed in the still image. In another embodiment, as described in further detail below, the frame may or may not include product data and the frame may be publicly displayed, allowing for another user or users to provide or add the product, merchant or marketing data. In another embodiment, the frame or a link or reference to the frame may also be electronically mailed or otherwise electronically transmitted to the user, whereupon the user may then forward this information to other users or in another embodiment the information may be sent directly to user-selected recipients.

In another embodiment, the user input may be transmitted to the broadcast station. The broadcast station may then capture the still image from the video and save it. In another embodiment, the still image may be saved as a bookmark using the play time from the beginning of the video to the point when the still image was saved, thus using less storage space compared to saving the whole still image as a bookmark. For example, the receiver may retrieve the actual data for the still image from the broadcast station when the user wishes to view the still image. In another embodiment, a collection of pixels usable for indicating or otherwise identifying the selected frame may also be saved.

The gallery 202 may display still images 204a, 204b, 204c and 204d. Each still image may be saved by the media player in response to a user input as described. The user input may be received from an input device, such as, for example, via a mouse click, a keyboard click, a television remote control button click or any other suitable input function.

Each still image may include at least one product, and each product may be associated with a set of metadata and product information. A product may be identified via a software tool which recognizes product outlines in a still image and flags the product for identification, such as, for example, software currently available from Avante Interactive. Product information and metadata may then be associated with each corresponding product.

The product information 210 may include a product image 212, depicting the selected product. For example, the product image 212 may be part of the product information saved with the product on the broadcast station. Alternatively, the product image 212 may be extracted from the still image that was saved in response to the user input and displayed in the gallery 202. The product information 210 may include a product name and a price 214 associated with the selected product, such as part of the product information saved with the product on the broadcast station.

The product information 210 may also include a product description 216 associated with the product. For example, the product description 216 may be a text description of the product, including features and benefits of the product. The product description 216 may be included with the video clip along with the rest of the product information 210. The product information 210 may also include a link to a merchant page (not depicted), where the user may purchase the product. Additionally, the third display may include additional interactive features, such as various active links 218. These exemplary active links include a first link to assist with the subsequent purchase of the displayed item. In one embodiment, a user selecting that active link may be directed to one or more commercial web sites or other means for purchasing the described item. Another exemplary active link may relate to bookmarking an item, which as described in further detail below and may include storing the item, the frame or another indicator relating to the product information for subsequent activities, such as, for example, purchasing the item at a later point in time. The third illustrated exemplary active link may also relate to sharing the product or information about the product. This may include uploading the frame, product information, an active link to the media file or other type of information to a web log or other information repository, such as for example when a person wants to provide a product review on a style-focused web log or initiate an inquiry about an item when the product information is missing or inadequate. It is recognized that other types of active links may also be provided for user interaction.

In one embodiment, the video player as described herein, may also be embedded or otherwise included in another application or stand alone program. For example, the viewer and the associated functionality may be included within a Flash program, whereby a user operating a browser application may be presented with a viewer offering the herein described functionality, where the browser operates in response to executable instructions associated with the underlying operating platform or program.

FIG. 3 illustrates a system for providing interactive video, in accordance with an example embodiment of the present invention. The system may broadcast a media content, such as a video clip, from a broadcast station to a set top box or a receiver. The set top box may communicate with a television set or other video display device, which displays the video clip to one or more viewers. The user (or several users) may interact with the receiver and the broadcast station as described below.

A user 300A may operate a set top box or receiver 302. The receiver 302 may communicate with a television set or other display configured to display the video clip. The user 300A may interact with the set-top box 302 using a remote control device or some other input device. The receiver 302 may be configured to display menus or other output data on the television set viewed by the user. The receiver 302 may also communicate with viewers 300B and 300C. It is understood that any number of viewers may view the television set in addition to the user 300A.

In another embodiment, the television set may be any other display device configured to display the video clip. For example, a portable media player such as a portable DVD player or a portable music or video playing device may be used. In another embodiment, the receiver and video display device may be a personal computer(s), configured to play video clips and communicate over the Internet.

The receiver 302 may communicate with a broadcast station 306 over a cable network 304. The broadcast station 306 may be configured to broadcast the video clip over the cable network 304 to a plurality of receivers, including receiver 302. Alternatively, the video clip may be streamed over the cable network 304 or completely downloaded before being played at a display device in communication with the receiver 302. The receiver 302 may be configured to execute a media player as depicted in FIGS. 1 and 2. The media player may be configured to play a video clip received from the broadcast station 306.

It is understood that while only one broadcast station 306 is depicted in FIG. 3, any number of broadcast stations may be distributed to broadcast the video clip to a plurality of receivers. For example, the broadcast stations may be geographically distributed to improve video clip delivery over the cable network 304. For example, the cable network 304 may be an existing cable television network. In another embodiment, the cable network 304 may be the Internet, a local area network (LAN), a wide area network (WAN) or any other communication network that can transport digital information. It is understood that any number of receivers may be in communication with the broadcast station 306 over the cable network 304.

The broadcast station 306 may access, store data in and receive data from a storage 308. For example, the storage 308 may be a re-writable storage medium such as a hard drive or a flash memory device. The storage 308 may be located near the broadcast station 302 or in a remote location, and may communicate and exchange data with the broadcast station 306 over a network.

The storage 308 may store video clips as media 310A, 310B and 310C. The video clips may be in a variety of digital formats. It is understood that the storage 308 may store any number of video clips, even though only three are depicted in FIG. 3. Each video clip may be associated with product information of the products depicted in the video clip.

The storage 308 may store still images saved by the user as still images 312A, 312B and 312C. The still images may be in a variety of digital formats. It is understood that the storage 308 may store any number of still images, even though only three are depicted in FIG. 3. Each still image may be associated with the user who saved the still image. Each still image may also be associated with a gallery into which it has been saved.

It is understood that the video clips may be any digital video clip. For example, the video clip may be music video, television shows, movies, political videos or home videos. Content may be divided into corporate content, expert content and user content.

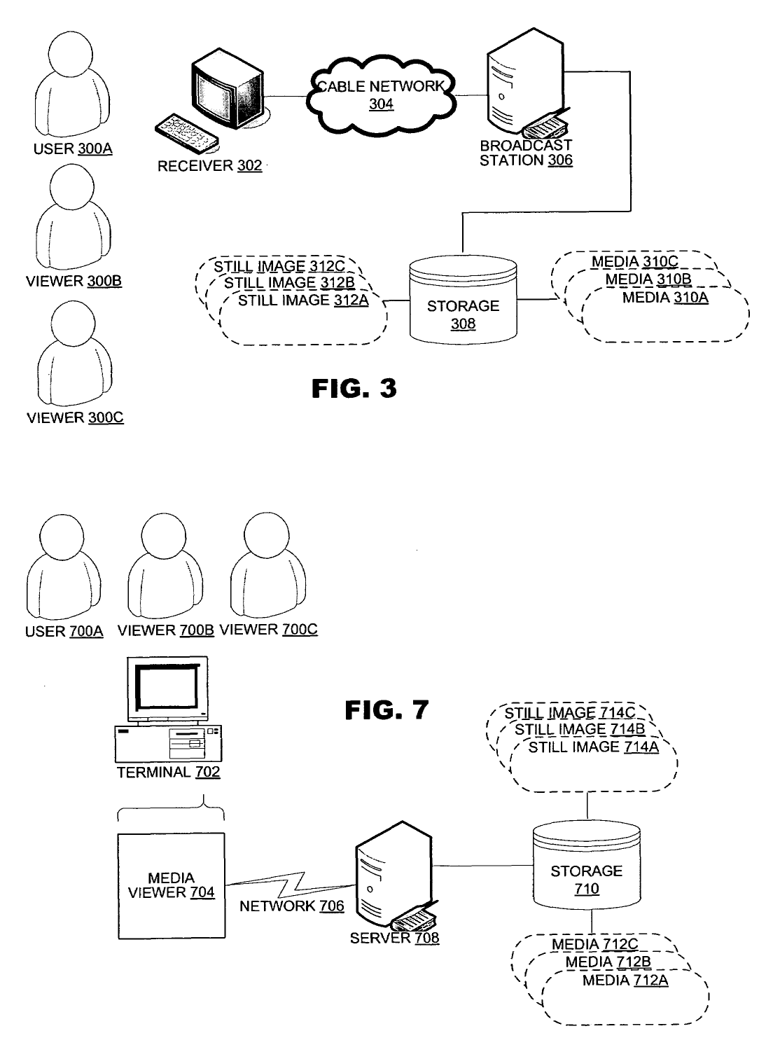

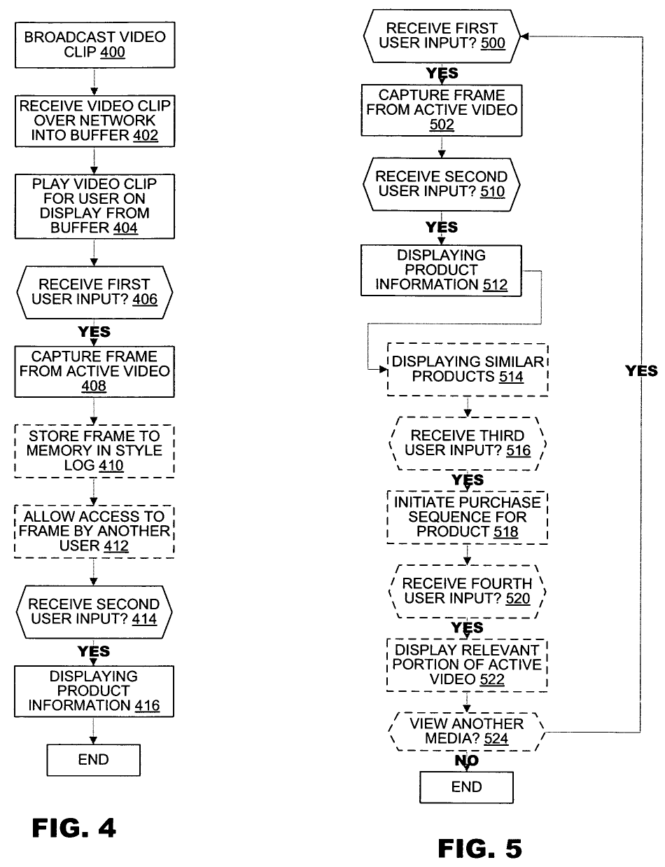

FIG. 4 illustrates a set of steps for playing a video clip for a user in response to user input, in accordance with an example embodiment of the present invention. These steps may be executed as depicted in FIGS. 3 and 7 and may play media content to a user and any number of other viewers on a display device that communicates with a receiver. The media content may be a digital video clip depicting products that could be purchased from an affiliated merchant's webpage or purchased through an affiliated or otherwise recognized merchant at a physical or non-internet based point of sale, for example a retail store accepting a printed coupon or a phone order system where a user may give a valid access or coupon code.

Referring to FIG. 4, a broadcast station may broadcast a video clip in step 400. In step 402, a receiver may receive the video clip over a cable network into a buffer. For example, the receiver may be configured to buffer a predetermined amount of the video content before transmitting it to the player, or in the alternative, buffer the entire video. The amount of the buffered video may be determined in part by traffic congestion on the cable network. The buffering may allow the user to pause the playback of the video, because the remainder of the video is saved in the buffer.

In step 404, the receiver may operate to transmit and display the video clip on a display device to the user and viewers from the buffer as the active video. The video clip may be played in response to an input by the user indicating a desire to view the video. For example, the receiver may be configured to receive a plurality of videos from the broadcast station at a time, such as multiple channels available on cable television. The user may select a specific video to watch. In another embodiment, there may be no buffer, and the video clip may be played as it is received from the broadcast station in real-time.

In step 406, the receiver may receive a first user input. The first user input may indicate that user's desire to save a frame on the display screen at the time the first user input is provided. For example, the receiver may include an input device configured to receive the first user input, such as a remote control input device. The first user input may be a user input indicating that a still image is to be saved from the media content being played at the receiver and viewed by the user. For example, a still image may be saved into the buffer from the currently playing active video clip, without adversely affecting the display of the active video. Adversely affecting the display may include any type of activity that significantly impedes a viewer's ability to watch the active video, such as causing the video to stop for an extended period of time, making significant portions of the video non-viewable or any other interference that could prevent users or viewers from watching or understanding the active video. Although, it is recognized that a pop-up menu having an opaque-ness to it, having a size that does not interfere with the viewing screen, a temporary or intermittent pausing of the active display or any other minor interruption is not considered to adversely affect the display.

In another embodiment, the receiver may receive inputs from one or more users for selecting or otherwise capturing frames. For example, one embodiment may include multiple users watching the active video display and different users requesting the capture of different frames at different times. In this embodiment, the system differentiates captured frames by the specific users, where one embodiment of differentiation may be based on a type of input. For example, with multiple users watching a single video display, each user may use a mobile device or any other suitable input device to capture frames, such as actively linking the mobile device to an internet or other communication portal and sequencing a frame capture command with the sequence of active video display. Where multiple users are actively capturing or bookmarking various video frames, the active video display may delay the display of a secondary display having the captured frames relative to the active video display, but may provide some level of frame capture confirmation, such as sending an image of the captured frame to the user mobile device, in one example.

In step 408, the receiver may save a still image from the media content by capturing a frame from the active video. Responsive to the first user input received in step 406, the still image may be saved. The broadcast station may include a web-accessible database. For example, the still image may be saved on the broadcast station in the web-accessible database. The still image may be added to a user gallery associated with the user. In another embodiment, the still image may be saved at the receiver location instead of the broadcast station location, such as a temporary buffer that stores the frame or an indicator for the frame while the active video maintain the continuous active display.

In step 410, the receiver may optionally save the frame to a user generated web log or other online location, such as disclosed in co-pending patent application entitled “User Generated Style Content” having Ser. No. ______. This user-generated content may be shared with other users over a network, such as the Internet, where various levels of functionality may be achieved, for example, a user-generated definition of the item, making the item commercially available for purchase and adding marketing and merchant information, among other interactive features.

In step 412, the broadcast station may optionally allow access to the frame captured in 408 by other users. For example, the frame may be placed in the user-generated style log in step 410 or similar collection on a storage device and made accessible to other users over a network.

In step 414, the receiver may optionally test whether a second user input has been received. If a second user input has been received, the system may proceed to step 416. The second user input may be a user selection of a product displayed in the captured frame. The user may utilize a pointing device, such as a mouse or a touch-sensitive screen, to select the desired product from the displayed captured frame. If a second user input has not been received, the procedure may wait for the second user input.

In step 416, the receiver may display the product information associated with the product selected by the user in step 414. For example, relevant product information may include, but is not limited to, a product image, a product description, a price and a merchant webpage link where the product may be purchased. The still image and product information may be displayed as part of a user gallery, where the user gallery displays a collection of still images and a list of products corresponding to a selected still image.

In the embodiment where the captured frame (or frames) is stored in a temporary location and the active video display is not interrupted or adversely affected, the second user input may be received at a later point in time for generating the secondary and tertiary displays. For example, in one embodiment a user may enter one or more first input commands to capture one or more frames while the active video is being displayed. The user may not want to disrupt the continuous viewing of the active video, therefore the captured frames, which may also include the frames themselves or indicators for the specific frames (e.g. time markers, blanking information, etc.), are temporarily stored. Then, when active video is over or the user wishes to terminate the active video, the second input command may generate the secondary and tertiary displays while occluding the active display window. Occlusion may include full occlusion in an overlay position, or partial occlusion may include staggered display windows, such as commonly found in a computer desktop operating platform. Therefore, the user choose to not interrupt the full display of the active video, but preserves the captured frames and may engage in retrieving specific product information at a later point in time.

FIG. 5 illustrates a set of steps for playing and displaying a video clip for a user, in accordance with another embodiment of the present invention. These steps may execute on a system as depicted in FIGS. 3 and 7, using a media player as depicted in FIGS. 1 and 2. The steps may include a step of displaying a media content to a plurality of users at a plurality of receivers, each receiver in communication with a display device, configured to display the media content.

In step 500, the media player may receive a first user input. For example, the receiver may include an input device configured to receive the first user input. The first user input may be a user input indicating that a still image is to be saved from the media content being played at the receiver. For example, a still image may be saved from the currently playing active video clip.

In step 502, the media player may save a still image from the media content by capturing a frame from the active video. Responsive to the first user input received in 500, the still image may be saved locally or remotely.

In step 510, the media player may optionally test whether a second user input has been received. For example, the second user input may be a user selection of a product displayed in the captured frame. The user may utilize a pointing device, such as a mouse or a touch-sensitive screen, to select the desired product from the displayed captured frame. If a second user input has not been received, the procedure may wait for the second user input. If a second user input has been received, the procedure may proceed to step 512.

In step 512, the media player may display the product information associated with the product selected by the user in step 510. For example, relevant product information may include, but is not limited to, a product image, a product description, a price and a merchant webpage link where the product may be purchased.

In another embodiment, the user may select a product from a still image that has not been identified in step 508. The product may be selected by outlining or otherwise identifying it in the still image. The selected unknown product may be submitted to the broadcast station, where an administrator may identify the product and associate product information with the product. In another embodiment, the selected unknown product may be published to the public, where other users may identify and associate product and merchant information with the product. The selected unknown product may be added to a queue of unknown products at the broadcast station for future identification.

In step 514, the media player may optionally display similar products to the product selected by the user in step 510. The media player may compare the product selected in step 510 with other products in a product database. The product database may include associations between products that are similar, as determined by some predefined or dynamic rule. For example, a still image which includes product information on a pair of blue jeans may trigger the media player to display similar blue jeans stored in the product database. The product database may utilize pattern-matching algorithms to determine similar products. For example, a product depicted in a video clip may be out of stock or no longer manufactured or available. In this example, the product database may suggest more recent products that are in stock and available for purchase.

In step 516, the media player may optionally test whether a third user input has been received. For example, the third user input may be a user input indicating a desire to purchase a selected product. The user may utilize a pointing device, such as a mouse or a touch-sensitive screen, to indicate the selected product from the displayed captured frame. If a third user input has not been received, the procedure may wait for the third user input. If a third user input has been received, the procedure may proceed to step 518.

In step 518, the media player may optionally initiate a purchase sequence for the product selected in step 516. The user's purchase request may be entered into a sales database for processing by a sales department. In another embodiment, the media player may forward the sale request to a relevant merchant for fulfillment, by, for example, sending it to the merchant's active link or web page that is included in the product information.

In step 520, the media player may optionally test whether a fourth user input has been received. For example, the fourth user input may be a user input indicating a desire to view a portion of the active video that displays the selected product. The user may utilize a pointing device, such as a mouse or a touch-sensitive screen, to indicate the selected product and a desire to view a portion of the active video. If a fourth user input has not been received, the procedure may wait for the fourth user input. If a fourth user input has been received, the procedure may proceed to step 522.

In step 522, the media player may optionally display a relevant portion of the media content corresponding to the products selected in step 516. The media player may play back a relevant portion of the media content where the products selected in step 516 are depicted. For example, the media player may play back all portions of the media content where the selected products are depicted. In another embodiment, the media player may select the most relevant portion of the media content that prominently depicts the selected products. The media player may include a set of user- or programmer-defined criteria used in selecting a relevant portion of the media content.

In step 524, the media player may optionally test whether the user would like to view another media item. For example, the receiver may ask the user whether the user wishes to view another media item. If yes, the procedure may return to step 500. If not, the procedure may terminate.

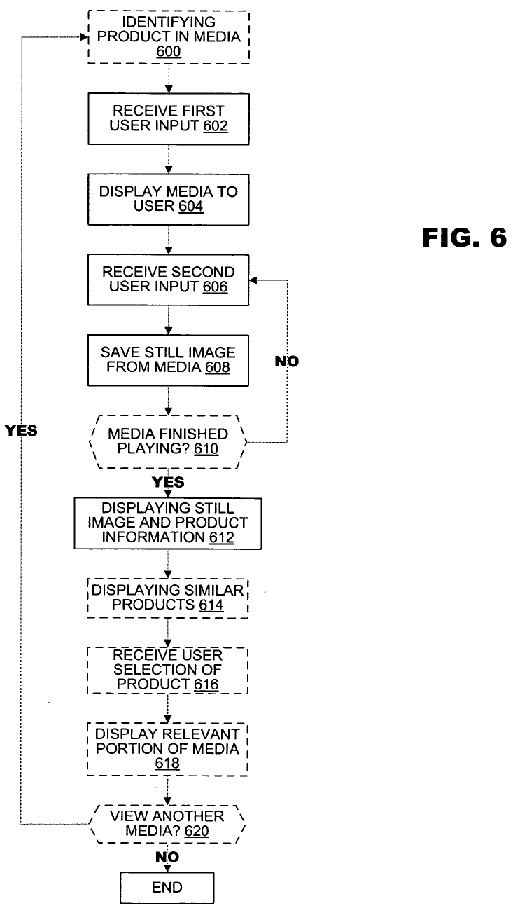

FIG. 6 illustrates a set of steps utilized by the present system for playing and displaying a video clip for a user, in accordance with one embodiment of the present invention. These steps may execute on a system as depicted in FIGS. 3 and 7, using a media player as depicted in FIGS. 1 and 2. The steps may include a step of playing back a media content to a user and at least one viewer.

In step 600, the system identifies products in the media content. For example, it may use software to automatically outline or highlight products in the media content and flag them for human identification. The system may create or store metadata reflecting the products and product information depicted in the media. In another embodiment, the system may receive product identification and information from an external source, such as the creator of the media content, and associate the product information with the corresponding product. In another embodiment, the system may retrieve product identification and information from a product database.

In step 602, the system may receive a first user input. For example, the media content may be played at a receiver configured to play back the video clip and receive user input. The first user input may be a user input indicating a media content to be played. For example, a plurality of video clips may be available from a broadcast station for playback at the receiver. The user may select one specific video clip to be played.

In step 604, the system may display the media content to the user. For example, the video clip may be streamed over a network to the receiver, or downloaded in its entirety to the receiver over the network. The receiver may play back the video clip to the user and other viewers on the display.

In step 606, the system may include receiving a second user input. The second user input may be a user input indicating that a still image is to be saved from the media content being played. The second user input may be received at the receiver from a variety of possible input devices, such as, for example, a mouse click or keyboard click.

In step 608, the system may save a still image from the media content. Responsive to the second user input received in step 606, the still image may be saved. For example, the still image may be saved at the broadcast station location in a web-accessible database or in the user-generated web log.

In step 610, the system may optionally test whether the media content has finished playing. If the media player has finished playing the content, the system may proceed to step 612. If the media player has not finished playing, the procedure may proceed to step 606 and await another user input to save a still image from the media content.

In step 612, the system may display a still image and product information, where the user has selected particular still images. The still image and product information may be displayed as part of a user gallery, where the user gallery displays a collection of still images and a list of products corresponding to a selected still image.

In step 614, the system may optionally display similar products. The system may compare the products displayed in step 612 with other products in a product database, similar to step 514 in FIG. 5. In step 616, the system may receive a user selection of products. The system may offer the functionality of displaying a relevant portion of the media content where a selected product was depicted. In another embodiment, the user may select product information from the user gallery.

In step 618, the system may display a relevant portion of the media content corresponding to the products selected in step 616. The system may play back a relevant portion of the media content where the products selected in step 616 are depicted. For example, the system may play back all portions of the media content where the selected products are depicted. In another embodiment, the system may select a most relevant portion of the media content that prominently depicts the selected products. The system may have a set of user- or programmer-defined criteria used in a selected, relevant portion of the media content.

In step 620, the system may optionally test whether the user would like to view another media file. If the user indicates yes, the procedure may return to step 600. If the user indicates no, the procedure may terminate.

FIG. 7 illustrates a system for providing interactive video, in accordance with an example embodiment of the present invention. The system may play media content, such as a video clip, to a plurality of viewers at a terminal 702. The user 700A may provide a user input from the terminal 702, indicating a desire to save a still image from the video clip.

The terminal 702 may be configured to execute a media viewer 704. The media viewer 704 may be a video player as depicted in FIGS. 1 and 2. The media viewer 704 may be configured to play a video clip for a plurality of viewers. The terminal 702 may be a personal computer or a television, or any other device with a processor for executing the media viewer 704 with a display for displaying the video clip.

The terminal 702 may be configured to receive a user input from the user 700A and transmit the user input to a server 708. The terminal 702 may be configured to receive and display a user gallery. For example, a user gallery may display at least one still image, a product image and product information. The user gallery may be as depicted in FIG. 2. The terminal 702 may then interact with the user 700A in browsing the products associated with the still images in the user gallery.

The receiver 704 may communicate with the server 708 over a network 706. For example, the network 706 may be the Internet, a local area network (LAN), a wide area network (WAN), or any other communication network that can transport digital information. While only one receiver is depicted in FIG. 7, it is understood that any number of receivers may be in communication with the server 708 over the network 706.

The server 708 may be configured to transmit video clips and associated product information over the network 706 to the terminal 702. For example, the video clips may be streamed or completely downloaded before being played at the terminal 702.

The server 708 may be configured to receive a user input from the user 700A, indicating a desire to save a still image from a video clip that is being transmitted from the server 708 and is playing on the terminal 702.

The server 708 may access and transmit data to and from a storage device 710 capable of storing video clips, such as media 712A, 712B and 712C. The video clips may be in a variety of digital formats. It is understood that the storage 710 may store any number of video clips, even though only three are depicted in FIG. 7. Each video clip may be associated with product and merchant information of products depicted in the video clip.

The storage device 710 may store still images saved by the user as still images 714A, 714B and 714C. The still images may be in a variety of digital formats. It is understood that the storage 710 may store any number of still images, even though only three are depicted in FIG. 7. Each still image may be associated with the user who saved the still image. Each still image may also be associated with a gallery into which it has been saved.

It is understood that the video clips may be any digital video clip. For example, the video clip may be a music video, a television show, a movie, a political video or a home video. Content may be divided into corporate content, expert content and user content. In another embodiment, a user may utilize the terminal 702 executing the media viewer 704 to perform additional functional tasks in response to programmable or otherwise executable instructions. For example, one action may be a user-selected frame capture operation to selectively capture of one or more frames of the played video. These captured frames may include product information associated therewith, or in another embodiment, the frame(s) may be uploaded to an online location where the user or other users can later view the frame(s) and add or otherwise supplement product and merchant information, as well as possibly offer opinions or other type of user-generated content. In another example, a programming application may allow for the hot-spotting of elements within a video or captured frames, such as described in further detail above. This hot-spotting allows for the designation of various items in the video, which can then be supplemented with user-generated content. This may be used in an amateur video where the user may still accomplish the desired product placement capabilities as described herein.

In another embodiment, the user 700A may access the user gallery at a different receiver location also in communication with the server 708 over the network 706. The user 700A may access the user gallery after the video clip has finished playing, and review all still images from the video clip that he has saved.

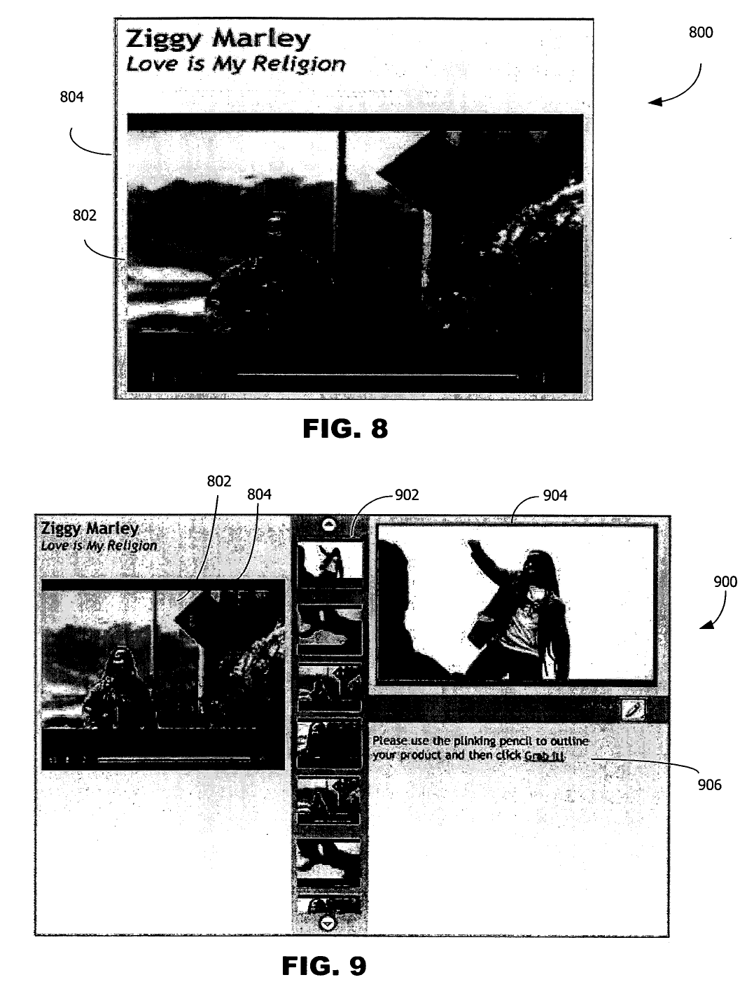

FIG. 8 illustrates a sample screen shot 800 as visible in the active video display 802 in a viewer 804, similar to the display 100 of FIG. 1, where a user may perform product linking operations. Product linking operations, also commonly referred to as PLINKING™ may include linking various products to different types of information, such as different users, different medias, related products, for example. Based on this product linking, active links may allow for greater levels of cross referencing different media, users, products and commercial activities. In this exemplary embodiment, a music video is being played, where the video may be viewed on a computing device and received or otherwise feed from a server or internet-accessible memory location acting as a broadcast station.

FIG. 9 illustrates a sample screen shot 900 of a full screen display including the video display 802 in the viewer 804, where the full screen display includes a plurality of thumbnail displays 902. In the illustrated embodiment, these displays are thumbnails of captured frames from the display 802. For example, as one or more users are watching the active video, they may be selecting various frames for capturing, where the frame capture selection does not adversely affect the playing of the active video in the viewer 804. As visible in the screen shoot 900, the up and down arrows flanking the thumbnail displays 902 indicates that there may be additional thumbnails not currently visible in the display.

Further visible in the sample screen shot, a secondary display 904 may be visible including a large display of the captured frame based on the thumbnail. This larger secondary display 904 provides a more readily visible display of the captured frame. This frame may include product information associated therewith, but in another embodiment a user may manually enter or otherwise associate the product information. For example, in the sample screen shot 900, instructions 906 allow for a user to manually enter an input for a product selection. In this sample embodiment, a user selects the hyper link “grab it” and software processing routines provide for the emergence of a pencil or other cursory item. Through user interaction, the user may direct the cursory item to outline or otherwise designate the particular item.

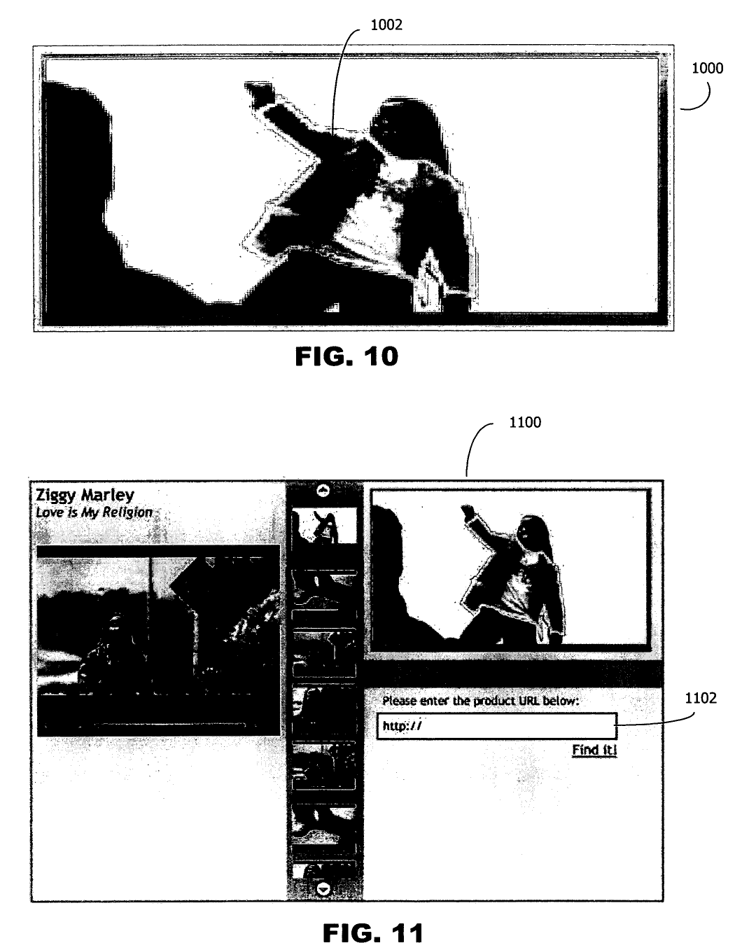

FIG. 10 illustrates a sample screen shot 1000, where a user has outlined the jacket 10002. As visible in a comparison of the secondary display 904 of FIG. 9 and the screen shot 1000 of FIG. 10, the jacket has been designated.

FIG. 11 illustrates a sample screen shot 1100 that includes the screen shot 1000 embedded therein. As part of the input product information, a user may thereupon enter a product URL other internet-based identification information. The URL may include listing the web site of a manufacturer, such as the user entering that the jacket is made by a particular designer or a particular brand. Upon entering the information, the user is provided the active link command text 1104, in this embodiment the phrase “Find it!”, where the user may then select the active link.

In software instructions or other programming operations, a search of the entered URL may be performed to acquire particular information. It is recognized that the user may not have the specific or exact information, therefore categorical information may be retrieved and used to further identify the product.

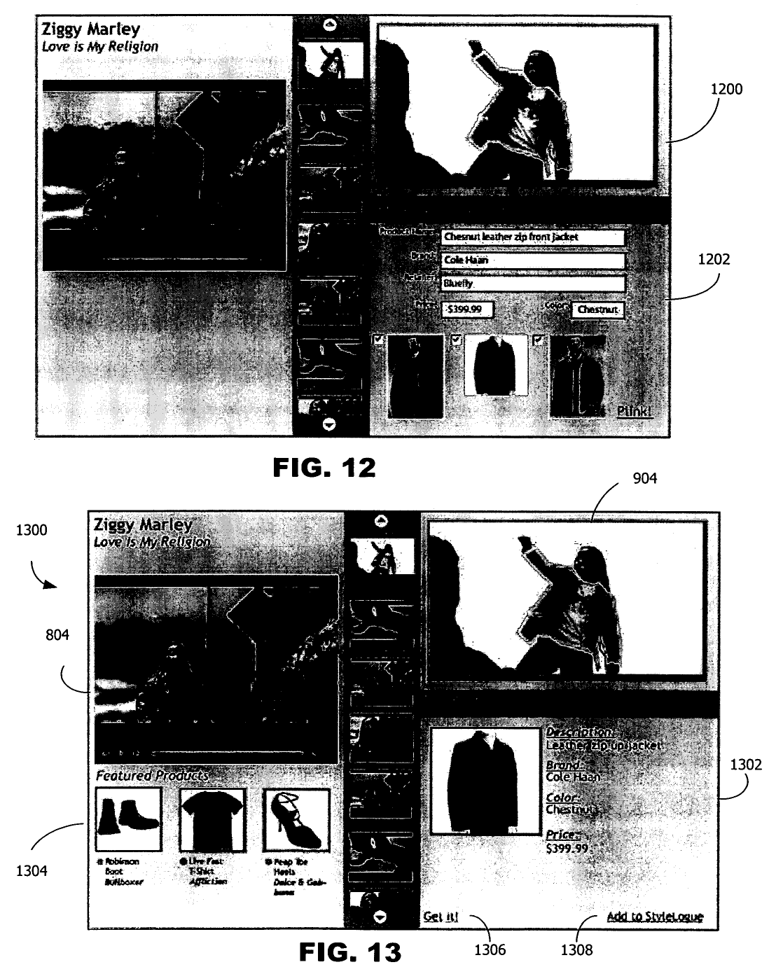

FIG. 12 illustrates a screen shot 1200 including product information selection fields. These fields may be pre-populated with selection choices such that the user may use existing known data selecting interface techniques to select the product. In this example, the user may granted the option of selecting the Product name, the brand, a particular retailer and the color. Various options for the product name may provide different selection options for sub-fields, therefore the information may be required to be entered or selected in a particular fashion. For example, upon selection of the Product Name, the brand name may be automatically filed in.

The retailer may also be filed in if there is only one choice, otherwise a user may select between different retailers. It is recognized that the user may receive credit or other type of incentive for referring a sale based on the product information, so the user may select a particular retailer based on price or compensation options, for example. Upon retailer selection, the price may be pre-set based on the retailer's parameters of what they are willing to sell the item for.

The product information 1202 may also include pictures that are provided from one or more sources. For example, the pictures may be provided from the manufacturer, designer, the seller or any other suitable source. In this embodiment, adjacent to the picture is a selection button that allows a person to select one or more pictures to be associated with the product information. Additionally, the user is presented with the active link command “Plink!” which would allow the user to perform a product linking operation.

In one embodiment, the selection of the PLINK™ command thereby links the product information directly to the video and/or the video frame. This linking may provide a conceptual connection between the product and the information generated or provided through the display, such as display 1202 with additional databases of information that therein allows an interwoven virtual presence of interrelated contextual web site entries.

The product linking not only generates the interconnection between various media including products, but also links users entries and related style or lifestyle related elements. For example, through the selection of the product linking, the selected jacket outlined in the display 1200 may be linked to other videos that include the jacket, may be linked to other user entries that display the jacket, may be linked to related accessories or other items that might compliment the jacket, among other possible links outside the scope of simply the immediate captured frame and/or the media in the active video display.

Product linking may be performed, in one embodiment, by associating various types of meta data or other identifiers for different product entries. Enabled electronic relationships between commonly associated products allows for the definition of linked elements. These linked relationships may be then viewed through one or more interfaces, including in one embodiment the video display as described herein, or in another embodiment may be viewed through a browser or other type of interactive or other interfacing technology.

FIG. 13 illustrates an embodiment of a display 1300 including the active video display 804, the enlarged frame 904 with the highlighted jacket and a plurality of frame thumbnails, as the display may indicate a possible display after the selection of the product linking command entry from the display of FIG. 12. The display 1300 also includes a product display field 1302 related to the jacket in the frame 902. The product information may be related as describing the jacket, or may also describe an item similar to the jacket, such as for example if the exact jacket is not determinable.

The linked product information, in this example being a leather zip up Chestnut colored jacket, is displayed with the related information and a selected image. Additionally, the display 1300 includes active link commands, one being for the user option to acquire or otherwise purchase the item by selecting the “Get It!” active link 1306. Another active link is the addition of the information to a user's web or “StyleLogue” through the active link “Add to StyleLogue” 1308, such as using the technique described above regarding the co-pending User Generated content web log patent application.

The display 1300 may also include additional display of featured products that may be featured in the active video or may be featured as being accessories to the illustrated product 1302. In one embodiment, product linking relationships may provide for the active video display to recognize that different users may have performed related product designation and information gathering operations and subsequently linked these items also. Therefore, by virtue of the relationship of the product information linked to the video in the display 804, the featured products 1304 may also be displayed. In one example, if the user selects one of the featured products, the display 1300 may be adjusted to show the feature product. Using the example of the boots, selection of the boots may cause the captured frame display 904 to change to a frame featuring the boots and the product description field 1302 may now include information on the boots, as well as active links to purchase the boots or add them to ones web log, while not affecting the playback of the media in the active video display 804.

In the display of the active video, captured frames, product information and related products, the viewer may also include the display of advertising information. In one embodiment, this advertising information may be contextual in nature, such as using any of the known existing contextual recognition routines for determining the associated advertising. For example, if the active video is a music video, an advertising link may include a link to an online music service capable of selling the audio recording for the music or an online retailer selling fan merchandise. This advertising, contextual or not, may be placed at any suitable location in the video display.

Through the video display, a primary display provides an active video. This video may include product information or may be manipulated to designate particular items and thereupon add the product information. The primary display may be allowed to maintain the display without being adversely affected, while a secondary display allows for viewing a captured frame and a third display or screen portion provides product information. This multi-viewer environment allows for the merging of the continuous or uninterrupted display of the active video with the ability to perform or otherwise interact and engage in commercial activities with products featured in the active video display.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for obtaining product information from an active video display, comprising:
responsive to a first user input, generating a secondary display from a primary display, wherein the primary display is an active video and the secondary display is a frame captured from the primary display; and
responsive to a second user input, generating a tertiary display from the secondary display, said tertiary display including product information about at least one item shown in the secondary display.

2. The method of claim 1, wherein the second display is captured from the primary display at about the time of the first user input.

3. The method of claim 1, further comprising providing at least one frame captured from the primary display to a user generated web log.

4. The method of claim 3, further comprising the at least one captured frame providing an active link for accessing at least a portion of the video of the active video display.

5. The method of claim 1, wherein the second display is stored to memory that is configured to store a plurality of frames captured from the primary display.

6. The method of claim 1, further comprising electronically recognizing at least one item visible in the active video.

7. The method of claim 1, further comprising:
responsive to a third user input, initiating a purchase sequence of the item shown in the tertiary display.

8. The method of claim 1, further comprising:
responsive to a fourth user input selecting the product information, displaying a portion of the active video relevant to the product information.

9. The method of claim 1, further comprising:
identifying products shown in the secondary display and associating product information with each identified product.

10. The method of claim 1, further comprising:
displaying product information of other products similar to the product information displayed in the tertiary display.

11. The method of claim 1, wherein the active video is broadcast from a broadcast station and received at a client.

12. The method of claim 11, wherein the client is selected from the group consisting of:
a set top box,
a television receiver,
a portable media device, and
a media playback device.

13. A computer readable medium storing instructions adapted to be executed by a processor to perform a method comprising:
responsive to a first user input, generating a secondary display from a primary display, wherein the primary display is an active video and the secondary display is a frame captured from the primary display; and
responsive to a second user input, generating a tertiary display from the secondary display, said tertiary display including product information about at least one item shown in the secondary display.

14. The medium of claim 13, wherein the secondary display is a frame captured from the primary display at about the time of the first user input.

15. The medium of claim 13, further comprising instructions providing at least one frame captured from the primary display to a user generated web log.

16. The medium of claim 14, wherein the at least one captured frame includes an active link for accessing at least a portion of the video of the active video display

17. The medium of claim 13, wherein the second display is stored to memory that is configured to store a plurality of frames captured from the primary display.

18. The medium of claim 13, further comprising instructions for electronically recognizing at least one item visible in the active video.

19. The medium of claim 13, wherein the method further comprises:
responsive to a third user input, initiating a purchase sequence of the item shown in the tertiary display.

20. The medium of claim 13, wherein the method further comprises:
responsive to a fourth user input selecting the product information, displaying a portion of the active video relevant to the product information.

21. The medium of claim 13, wherein the method further comprises:
identifying products shown in the secondary display and associating product information with each identified product.

22. The medium of claim 13, wherein the method further comprises:
displaying product information of other products similar to the product information displayed in the tertiary display.

23. The medium of claim 13, wherein the active video is broadcast from a broadcast station and received at a client.

24. The medium of claim 23, wherein the client is selected from the group consisting of:
a set top box,
a television receiver,
a portable media device, and
a media playback device.

25. An apparatus for obtaining product information from an active video display, comprising:
a processor; and
a memory coupled to said processor, said memory storing instructions adapted to be executed by said processor to generate a secondary display from a primary display responsive to a first signal received from a user input device, wherein the primary display is an active video and the secondary display is a frame captured from the primary display at about the time of the first user input, and to generate a tertiary display from the secondary display responsive to a second signal received from the user input device, said tertiary display including product information about at least one item shown in the secondary display.

26. The apparatus of claim 25, wherein the secondary display is a frame captured from the primary display at about the time of the first user input.

27. The apparatus of claim 25, wherein the processor is further configured to provide at least one frame captured from the primary display to a user generated web log.

28. The apparatus of claim 27, wherein the at least one capture frame includes an active link for accessing at least a portion of the video of the active video display.

29. The apparatus of claim 25, wherein the second display is stored to memory that is configured to store a plurality of frames captured from the primary display.

30. The apparatus of claim 25, wherein the process is further configured to electronically recognize at least one item visible in the active video.

31. The apparatus of claim 25, wherein the processor is further configured to respond to a third user input, initiating a purchase sequence of the item shown in the tertiary display.

32. The apparatus of claim 25, wherein the processor is further configured to respond to a fourth user input selecting the product information, displaying a portion of the active video relevant to the product information.

33. The apparatus of claim 25, wherein the processor is further configured to identify products shown in the secondary display and associating product information with each identified product.

34. The apparatus of claim 25, wherein the processor is further configured to display product information of other products similar to the product information displayed in the tertiary display.

35. The apparatus of claim 25, wherein the active video is broadcast from a broadcast station and received at a client.

36. The apparatus of claim 35, wherein the client is selected from the group consisting of:
a set top box,
a television receiver,
a portable media device,
and a media playback device.
